(19) United States
(12) Patent Application Publication
(10) Pub. No.: US 2004/0020071 A1
(43) Pub. Date: Feb. 5, 2004

(54) Oil removing device for cleaning pipes that are present in the form of coils

(76) Inventors: Willi Johnen, Roetgen (DE); Glynn Jones, Raeren (BE)

Correspondence Address: JORDAN AND HAMBURG LLP, 122 EAST 42ND STREET, SUITE 4000, NEW YORK, NY, 10168, US

(21) Appl. No.: 10/416,760

(22) PCT Filed: Sep. 6, 2002
(86) PCT No.: PCT/DE02/03288

(30) Foreign Application Priority Data
Sep. 10, 2001 (DE) 101 44 509.1

(51) Int. Cl. F26B 19/00; F26B 25/06

(52) U.S. Cl. 34/226; 34/218; 34/201

(57) ABSTRACT

The invention relates to an oil removing device for cleaning pipes that are present in the form of coils (13). Same device comprises a furnace that accommodates and heats the pipes, with or without associated cooling zone, and a gas guiding device (15, 16′) for feeding a scavenging gas to or removing it from the pipes. Said gas guiding device is provided with means for detachably and sealingly establish a link with a gas feed line and a gas discharge line. The aim of the invention is to configure the link with the pipes in as easy and reliable a manner as possible. For this purpose, the device is configured in such a manner that both ends of every pipe are separately connected to one and the same connecting head (4) that has a gas inlet (5) and a gas outlet opening the axially aligned therewith. The end (7) of the gas feed line and the end (8) of the gas discharge line are opposite each other and can be displaced along with the gas inlet opening and/or the gas outlet opening while sealingly connected.

### DESCRIPTION

The present invention relates to an oil removal device for cleaning pipes provided in the form of coils, having a furnace which receives and heats the pipes, with or without an assigned cooling zone, and a gas guiding device for introducing and removing scavenging gas into the pipes and/or out of the pipes, the gas guiding device having means for detachable, tight connection to a gas supply line on one side and a gas removal line on the other side.

An oil removal device according to the species is known from European Patent Application 0659907 B1. In the device described there, the coil is heated in a furnace chamber and a gas is introduced and removed via a gas supply line to clean the inside of a pipe. In this case, the connection to the ends of the pipe to be cleaned is produced via two couplings, which are each attached to a pull and push rod and are moved toward the corresponding counterparts independently from one another and at diametrically opposing sides of the furnace chamber. This connection device is connected to the pull and push rod via a universal joint, so that a gas-tight connection may be achieved even if the support stand of the coil is positioned slightly twisted in the furnace chamber and the connection ends of the connection device are not parallel to one another.

A great disadvantage of the device described results from the gas supply and gas removal connections, which are positioned separately from one another and are independent of one another. The tightness of these connections is determined by the contact pressure of the connection device. In the event of high contact pressure, there is therefore the danger that the support stand will be displaced or deformed by the mechanical forces introduced via the connection device, so that leaks may arise.

The problem of the present invention is to provide an oil removal device according to the species which allows simple and gas-tight connection of the coils to the gas supply device.

This problem is solved according to the present invention for a device of the type initially described in that both ends of each pipe are separately connected to one and the same connection head, which has a gas inlet opening and a gas outlet opening aligned axially thereto, and the ends of the gas supply line and the gas removal line are movable opposite to one another and simultaneously having a sealed connection with the gas inlet opening and gas outlet opening.

Because the inlet opening is positioned opposite and axially aligned to the outlet opening and both openings are positioned lying near one another in one and the same connection head, the gas removal line is used as a holder for receiving the mechanical pressure of the gas supply line, so that the gas removal line and the gas supply line clamp the connection head between them, so that slipping of the coil or the stand due to the mechanical forces of the gas supply and gas removal lines is therefore excluded.

The device according to the present invention may also be implemented so that the connection head is rigidly fixed or integrated in the stand which is used to receive coils lying on top of one another. Therefore, this connection head is positioned relative to the furnace chamber by positioning the stand and the stand is fixed in its relative position to the furnace chamber when the connection to the gas supply and gas removal lines is produced. Furthermore, a stand of this type may be furnished with multiple coils outside the furnace chamber and may subsequently be moved into the furnace chamber for treatment.

Furthermore, the device according to the present invention may be implemented so that the two ends of the coils are separately connected for gas supply and gas removal via pipelines connected to the stand, so that therefore a fixed connection between the connection head and a gas distribution system is provided.

Furthermore, the device according to the present invention may be implemented so that the two pipe ends of each coil are each connected via a flexible coupling to the pipeline which supplies and removes the gas. Therefore, the connection of a coil to the gas supply line and gas removal line is significantly simplified, since geometric tolerances of the external shape of the coil may be compensated for through the flexible couplings.

Furthermore, the device according to the present invention may be implemented so that at least the sections of the gas supply line and the gas removal line neighboring the connection head are mounted so they are movable aligned in a straight line until they press against the gas inlet opening and/or the gas outlet opening, and back. Therefore, the connection parts of the gas supply and gas removal lines adjoining the connection head must only perform a simple straight line movement in order to connect to the connection head.

Furthermore, the device according to the present invention may be implemented so that at least the sections of the gas supply line and gas removal line neighboring the connection head are movable along a curved path until they press against the gas inlet opening and/or the gas outlet opening, and back. The connection parts of the gas supply line and gas removal line adjoining the connection head must then only be moved along the curved path in order to produce a gas-tight connection to the connection head.

Furthermore, the device according to the present invention may be implemented so that the gas supply line and the gas removal line are pneumatically or hydraulically driven in their movement. The contact pressure of the connection parts on the connection head necessary for a gas-tight connection may thus be applied through the drive of the connection parts of the gas supply line and gas removal line.

Furthermore, the device according to the present invention may be implemented so that the sections of the gas supply line and the gas removal line neighboring the connection head are mounted pivotably to adjust for any tolerances as the gas line and connection head meet. In this way, the seal to the connection head in the furnace chamber may be made even more reliable.

Furthermore, the device according to the present invention may be implemented so that the sections of the gas supply line and the gas removal line neighboring the connection head are implemented as axially flexible. In this way, the tolerances arising in the axial direction during positioning of the connection head in the furnace chamber are compensated without the stand being displaced through the incident pressure.

Finally, the device according to the present invention may be implemented so that the pipeline for the gas to be removed has multiple channels which are separate from one another, which each communicate with the outlet of a pipe of a specific coil. Vice versa, the pipeline for the gas to be supplied may also have multiple channels which are separate from one another, which each communicate with an inlet of a pipe of a specific coil. This allows measurement and regulation of the gas flow through a specific coil. dr

In the following, an embodiment of the device according to the present invention is described on the basis of the drawing.

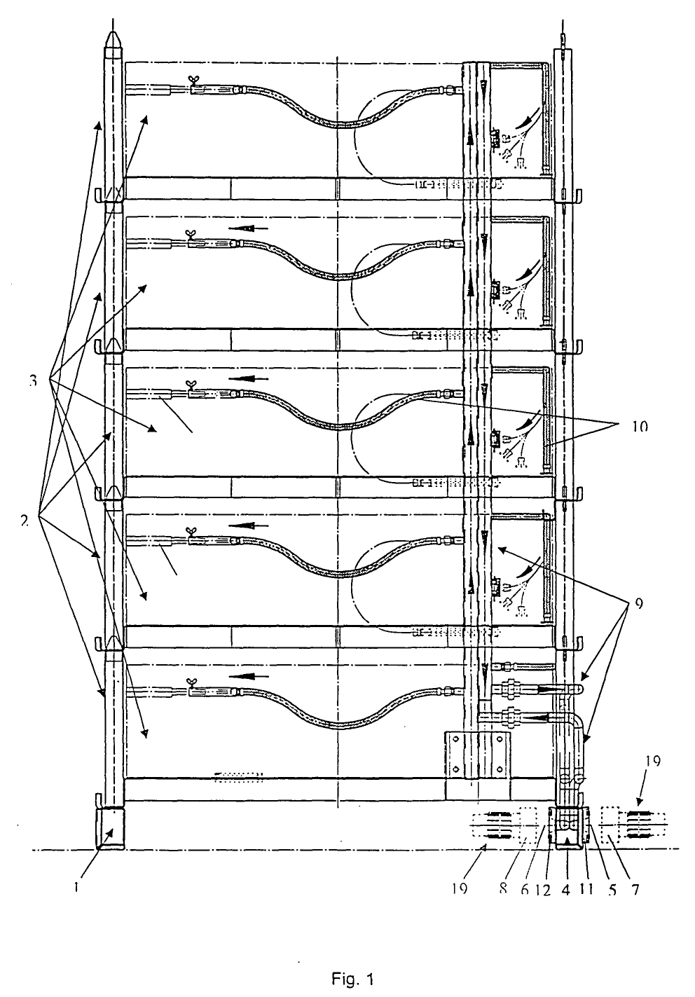

FIG. 1 shows a vertical section through a stand for receiving multiple coils having a connection head integrated into the stand,

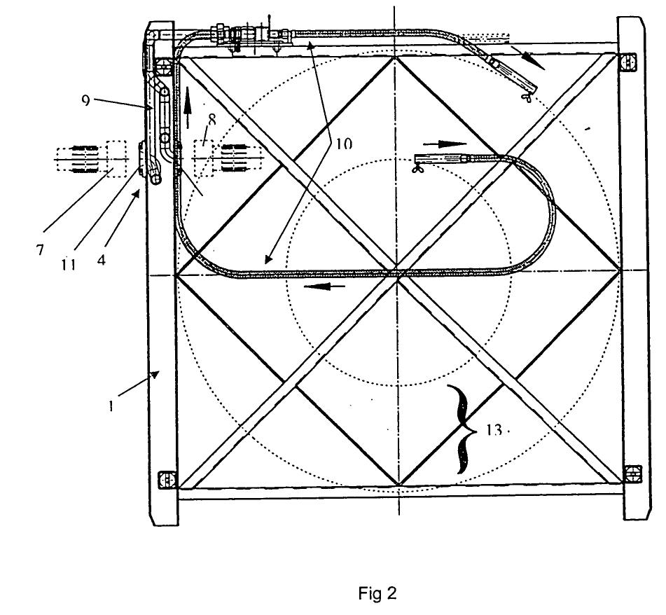

FIG. 2 shows a horizontal section through the stand having an integrated connection head,

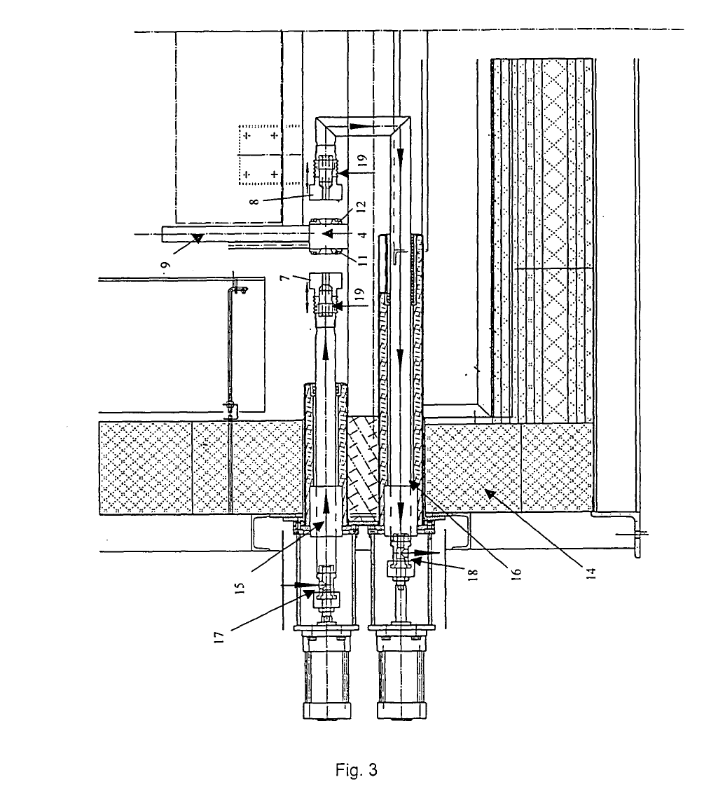

FIG. 3 shows a section through the furnace wall, the gas supply line and gas removal line, and the stand having an integrated connection head.

The stand 1 (FIG. 1) has attachments 2 positioned on top of one another, which each have a space 3 for receiving the coils. A connection head 4 having a gas inlet opening 5 and an opposing gas outlet opening 6 is integrated into the stand 1. The ends 7 and 8 of the gas supply line 15 and gas removal line 16 connected to the connection head 4 are shown with dashes. The gas inlet opening 5 and gas outlet opening 6 are aligned axially and opposite to the openings 5, 6 of the connection head 4. It may be clearly seen that the openings of the connection parts 7, 8 of the gas supply line 15 and gas removal line 16 and the inlet and outlet openings 5, 6 of the connection head 4 are aligned on one axis, so that the connection parts 7, 8 are to be moved along the axis in order to produce a connection to the connection head 4. FIG. 2 shows the lower part of the stand 1, in which the connection head 4 is integrated in such a way that it comprises a connection part 11 provided for gas supply and a connection part 12 provided for gas removal. These connection parts 11 and 12 are fixed to the stand 1 and receive the pipelines 9, also fixed to the stand 1, on the other side. The flexible couplings 10, which conduct the gas into a coil 13 (indicated with dashes), are connected to these pipelines 9. Furthermore, it may be seen that the openings of the connection parts 11, 12 and the openings of the connection parts 7, 8 of the gas supply line 15 and gas removal line 16 are aligned along one axis.

FIG. 3 shows a section through the furnace wall 14, through the gas supply line 15 and gas removal line 16 having the connection parts 7 and 8 attached thereto, and through the connection head 4 having the associated connection parts 11 and 12. The flow of the gas begins here with the supply 17 into the gas supply line 15. Subsequently, the gas is conducted through the connection parts 7 and 11 into the pipelines 9. From there, it is introduced into and removed from the coils and subsequently guided via the pipeline 9 and the connection part 12 into the gas removal line 16 until it is removed through the removal 18. As in FIGS. 1 and 2, it is clear here that the openings of the connection parts 7, 8 of the gas supply line 15 and gas removal line 16 are aligned with the openings of the connection parts 11, 12 of the connection head 4 along a shared axis, so that the gas supply line 15 and the gas removal line 16 are to be moved along this axis in order to achieve a gas-tight connection via the connection parts 7, 8, 11, and 12. The axial flexibility of the gas supply line 15 and gas removal line 16 necessary to compensate for tolerances, as well as the pivotable mounting of the connection parts 7, 8, are indicated by the elements 19.

### List of Reference Numbers

| | |
|---|---|
| 1 | stand |
| 2 | stackable attachment having spacer for receiving a coil |
| 3 | space for receiving a coil |
| 4 | connection head |
| 5 | inlet opening of the connection head |
| 6 | outlet opening of the connection head |
| 7 | connection part of the gas supply line |
| 8 | connection part of the gas removal line |
| 9 | pipelines |
| 10 | flexible coupling |
| 11 | connection part (inlet) of the connection head |
| 12 | connection part (outlet) of the connection head |
| 13 | coil |
| 13a | pipe ends of a coil |
| 14 | furnace wall |
| 15 | gas supply line |
| 16 | gas removal line |
| 17 | supply of inert gas |
| 18 | removal of inert gas |
| 19 | flexible connection element |

1. An oil removal device for cleaning pipes provided in the form of coils (13), having a furnace, which receives and heats the pipes, with or without an assigned cooling zone, and a gas guiding device (15, 16) to introduce and remove scavenging gas into the pipes and from the pipes, respectively, the gas guiding device having means for detachable, tight connection to a gas supply line (15) on one side and a gas removal line (16) on the other side, respectively, characterized in that both ends of each pipe are separately connected to one and the same connection head (4), which has a gas inlet opening (5) and a gas outlet opening (6) aligned axially thereto, and the end (7) of the gas supply line (15) and the end (8) of the gas removal line (16) are directed opposite to one another and simultaneously movable with the gas inlet opening and/or the gas outlet opening in a sealed connection.

2. The device according to claim 1, characterized in that the connection head (4) is integrated into a stand (1), movable relative to the furnace, for holding multiple coils (13) positioned on top of one another.

3. The device according to claim 2, characterized in that the two ends (13a) of each pipe (13) are connected separately to the connection head (4) for gas supply and/or gas removal via pipelines (9) connected to the stand.

4. The device according to claim 3, characterized in that the two pipe ends (13a) of each coil (13) are each connected via a flexible coupling (10) to the pipeline (9) which supplies and/or removes gas.

5. The device according to one of the preceding claims, characterized in that at least the sections (7, 8) of the gas supply line (15) and the gas removal line (16) neighboring the connection head (4) are mounted so they may be moved aligned in a straight line until they press against the gas inlet opening (5) and/or the gas outlet opening (6), and back.

6. The device according to one of claims 1 to 4, characterized in that at least the sections (7, 8) of the gas supply line (15) and the gas removal line (16) neighboring the connection head (4) are movable along a curved path until they press against the gas inlet opening (5) and/or the gas outlet opening (6), and back.

7. The device according to one of the preceding claims, characterized in that the gas supply line and the gas removal line are pneumatically or hydraulically driven in their movement.

8. The device according to one of the preceding claims, characterized in that the sections of the gas supply line and the gas removal line neighboring the connection head are mounted pivotably to adjust for any tolerances as the gas line and the connection head meet.

9. The device according to one of the preceding claims, characterized in that the sections (7, 8) of the gas supply line (15) and the gas removal line (16) neighboring the connection head are implemented as axially flexible.

10. The device according to one of claims 2 to 9, characterized in that the pipeline (9) for the gas to be removed has multiple channels, which are separate from one another, which each communicate with the outlet of a pipe of a specific coil (13).
